(19) United States
(12) Patent Application Publication
(10) Pub. No.: US 2005/0240508 A1
(43) Pub. Date: Oct. 27, 2005

(54) Multi-parties transaction system

(75) Inventor: Chih-Hung Chien, Taoyuan (TW)

Correspondence Address: WELSH & KATZ, LTD, 120 S RIVERSIDE PLAZA, 22ND FLOOR, CHICAGO, IL, 60606, US

(73) Assignee: MITAC International Corp., Hsinchu (TW)

(21) Appl. No.: 10/832,189

(22) Filed: Apr. 26, 2004

(51) Int. Cl. G06F 17/60

(52) U.S. Cl. 705/37

(57) ABSTRACT

A multi-parties transaction system is disclosed to solve problems when affiliates purchase the same goods from different sellers at different prices. In the system, multi-buyer needs and offers from seller affiliates are integrated so as to provide a quotation system in which one buyer representative and a plurality of seller representative participate to the quotation. The process includes: integrating product needs from affiliates of one buyer company to elect a buyer representative; integrating offers from affiliates of one seller company to set one quotation price and electing one seller representative; comparing the quotation prices offered by different seller representatives to obtain an order price offered by a winner seller representative; the buyer representative making an order at the order price to the winner seller representative; and allocating the order to other affiliates of the winner seller representative.

### BACKGROUND OF INVENTION

1. Field of Invention

The present invention relates to a multi-parties transaction system, and more particularly to a multi-parties transaction system that integrates needs of multi-buyers and offers from multi-sellers.

2. Related Art

A company usually has affiliates or branches to meet globalization or financial needs. Further, a manufacturing company may have more than one manufacturing plant or production line. They are distributed over the world according to the materiel needs, low labor cost, changes in business models, etc. In a competitive environment, merges between companies are means to increase the competition. All these situations render the transaction between the sellers and buyers more complex. For example, sellers “A”, “B”, “C” offer a same materiel to buyers “1”, “2”, “3” at three different prices. The sellers “A”, “B”, “C” may be affiliates of one company, while the buyers may be affiliates of another company. It would be not economic if the same company buys the same goods from one goods source at different prices.

In a conventional transaction mode, a buyer surveys the prices offered by the sellers and makes an order to the one who can offer the lowest quotation price. However, owing to a closed quotation procedure, disputes concerning the order price may occur afterwards. Therefore, it is more preferable to have an open quotation. As the Internet develops, an open quotation can be held via Internet. Usually, when companies “A”, “B”, “C” have materiel needs, quotations will be held in a traditional way or via Internet, which also encounters the above problem in which the same products are bought at different prices. When the needs of companies “A”, “B”, “C” could be integrated into a substantial amount of products to be purchased, the prices can be reduced and only one quotation is needed. As to the seller side, the sellers “1”, “2”, “3” being affiliates of one company can cooperate to win the order without competition between each other.

In the case that buyers “A”, “B”, “C” respectively have manufacturing plants “a”, “b”, “c” that need materiel and are at different locations, and the corresponding local suppliers are respectively sellers “1”, “2”, “3”, the position of seller “1” may be advantageous in respect of buyer A, due to a location closer to the purchaser. Then, seller “1” directly delivers the materiel to manufacturing plant “a”.

A reason why company affiliates buy the same product at different prices is due to the logistics cost for delivery from different suppliers. Therefore, integrating all the needs of buyers “A”, “B”, “C” does not need to reduce the price but reasonably keeps the profit compared to performing separate quotations. On the other hand, the offers of the affiliates of one Seller Company could be integrated for mass supplies to increase the competition in the quotation. After one seller representative has won the quotation, it allocates the order to other affiliates and the local affiliate delivers goods to the buyer in the same area, which reduces the logistic costs.

### SUMMARY OF INVENTION

It is one object of the invention to provide a multi-parties transaction system that integrates needs of all buyers and offers from sellers so that one buyer representative and a plurality of seller representatives participate in the quotation. After the quotation, the buyer representative makes an order to the winner seller representative, who then allocates the order to other seller affiliates. The goods will be delivered by the closest seller affiliates.

In order to achieve the above and other objectives, the multi-parties transaction system of the invention includes a buyer setting module, a seller setting module, a comparing module, an ordering module, and an allocating module.

The invention further provides a multi-party transaction process including the following steps. Product needs of affiliates of one Buyer Company are integrated so as to elect a buyer representative. Offers from affiliates of one Seller Company are integrated to elect one seller representative. All the quotation prices offered by different seller representatives are compared, to select the lowest price, and the seller representative who offers the lowest price wins the quotation. The buyer representative makes an order to the winner seller representative. The winner seller representative allocates the order to other affiliates.

It will be understood that the foregoing summary encompasses some of the many features of the invention, and does not constitute an exhaustive description of all the aspects of the invention. Therefore, the summary of the invention should not be construed in a way to limit the scope of the invention as described in the claims. To provide a further understanding of the invention, the following detailed description illustrates embodiments and examples of the invention.

### BRIEF DESCRIPTION OF THE DRAWINGS

FIG. 1A schematically illustrates a conventional quotation method;

FIG. 1B is a schematic view of a multi-parties transaction system and the operation thereof according to one embodiment of the invention;

FIG. 2 is a block diagram of a multi-parties transaction system according to one embodiment of the invention; and

FIG. 3 is a flowchart of a multi-parties transaction system and its operation according to one embodiment of the invention.

### DETAILED DESCRIPTION OF THE INVENTION

The following description of the present invention is intended to be illustrative only and not limiting.

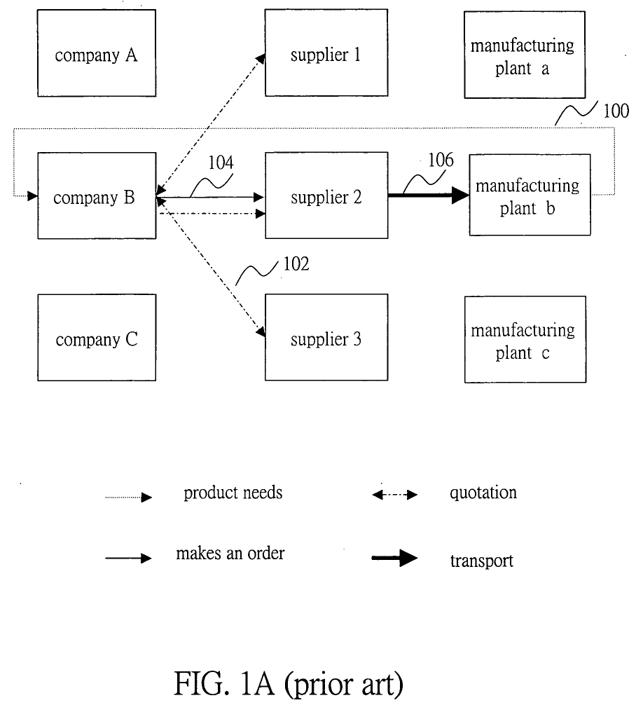

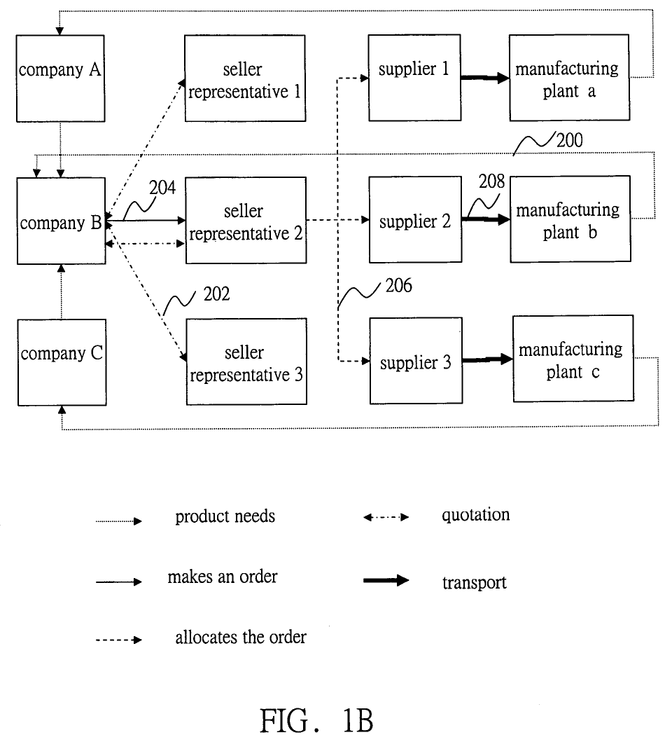

FIG. 1A schematically illustrates a conventional quotation method. As illustrated, when a manufacturing plant “b” has a materiel need, it reports this need to the concerned department of its company B (step 100). The company “B” asks its suppliers to join the quotation (step 102). The company “B” makes an order to the winning supplier (step 104). Then, the winning supplier transports the goods to the manufacturing plant “b” (step 106). Similarly, when the manufacturing plants “a”, “c” also have materiel needs, their respective companies “A”, “C” must held respective auctions, which complicates the transaction between buyers and sellers. Furthermore, the respective quotations held by different companies cannot unify the price of the same item.

Therefore, the invention provides a simplified multi-parties transaction mode to purchase goods at the lowest price. In the invention, only one buyer representative is elected among buyers who have the same materiel needs to hold the quotation. Similarly, it can be applied to the seller side. One seller representative is elected to join the quotation.

FIG. 1B is a schematic view of a multi-parties transaction system and the operation thereof according to one embodiment of the invention. As illustrated, when the manufacturing plants “a”, “b”, “c” have materiel needs, they respectively report to their companies “A”, “B”, “C”, and the needs are integrated (step 200). One buyer representative (company B) is elected to hold a quotation (step 202). All the suppliers of the respective companies “A”, “B”, “C” are asked to elect one seller representative to join the quotation. Therefore, there are seller representatives “1”, “2”, “3”, for example. All the seller representatives are invited to join the quotation. A seller representative, for example, seller representative “2”, wins the quotation. Then, company “B” makes an order for the winner seller representative 2 (step 204). The winner seller representative 2 allocates the order over its suppliers (step 206). The suppliers respectively transport goods to the manufacturing plants “a”, “b”, “c” (step 208).

Under this operation mode, the suppliers of the same company turn their competition relationship into a cooperation relationship. The winning seller representative allocates the order, which is flexible for goods distribution. On the other hand, local goods distribution can be done to further save logistics costs.

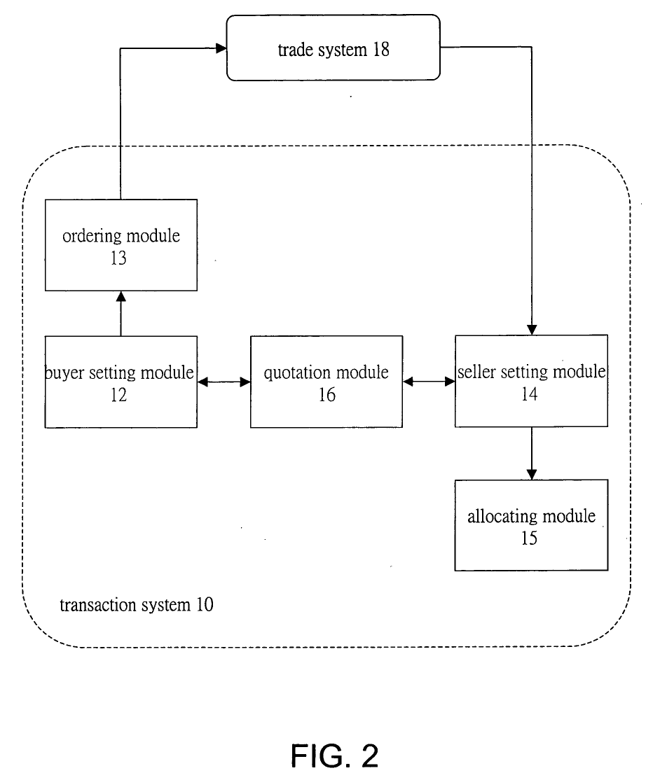

FIG. 2 is a block diagram of a multi-parties transaction system according to one embodiment of the invention. As illustrated, the transaction system 10 includes a buyer setting module 12, an ordering module 13, a seller setting module 14, an allocating module 15 and a quotation module 16.

The buyer setting module 12 can be implemented to purchase the same products for company affiliates. The buyers integrate the product needs and make a transport agreement according to all the buyers' needs. This agreement describes a destination for the goods. A buyer representative is elected according to the amount of purchases, the type of product to be purchased or the buyer's location. After the quotation, the buyer representative makes an order for the seller representative via the ordering module 13.

The seller setting module 14 is operable to enable the affiliates to join one quotation or for a seller ally to join the quotation. The affiliates of one company have business codes that can be easily found to elect the seller representative. Each seller representative is invited to join the quotation via the quotation module 16. The election rule of the seller representative corresponds to that implemented to elect the buyer representative. For example, when the buyer representative is the one who has the maximum purchase amount, and the seller representative is the one who is able to offer the maximum quantity of products. After the quotation, the winning seller representative obtains the order from the buyer representative via the trade system 18 and then allocates the order to its affiliates.

The quotation module 16 is used to estimate the logistics costs for the affiliates according to the location described in the agreement. The seller affiliates set a quotation price. Based on this, the seller representative joins the quotation. After the quotation is completed, a winning seller representative wins the quotation with the lowest price. The result is respectively transmitted to the buyer representative set by the buyer setting module 12 and to the seller representatives set by the seller setting module 14.

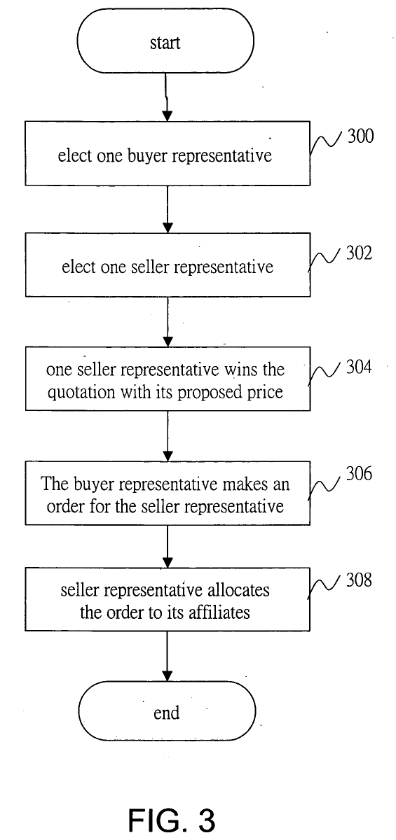

FIG. 3 is a flowchart of a multi-parties transaction system and its operation according to one embodiment of the invention. As illustrated, the system includes searching buyer affiliates that have the same business code to elect one buyer representative according to a transport agreement that is made according to all the purchase needs (step 300). All the seller affiliates with the same business code are found and one seller representative is elected among those affiliates (step 302). One quotation price is made according to the transport agreement, and upon the basis of this quotation price the representative joins the quotation. After the quotation is completed, one seller representative wins the quotation with its proposed price, which becomes the order price (step 304). The buyer representative then makes an order for the seller representative according to the final order price (step 306). The winner seller representative allocates the order to its affiliates (step 308).

Those skilled in the art will readily understand that the above description is only illustrative of specific embodiments and examples of the invention, which should not be construed in a limiting way. Therefore, the invention should cover various modifications and variations made according to the structure and operations described herein, provided they fall within the scope of the invention as defined in the following appended claims.

1. A multi-parties transaction system, implemented in a quotation operation between companies, the system comprising:
a buyer setting module, integrating product needs of affiliates of one buyer company, electing a buyer representative and setting a transport agreement according to all the needs;
a seller setting module, operable to integrate offers of affiliates of one seller company, wherein one quotation price is set according to the transport agreement and one seller representative is elected; and
a quotation module, comparing the quotation prices from different companies to obtain an order price offered by a winner seller representative of the quotation.

2. The system of claim 1, wherein the transport agreement describes a destination for the goods.

3. The system of claim 1, wherein the seller setting module further includes a ordering module used to make an order to the winner seller representative according to the order price.

4. The system of claim 1, wherein the affiliates of one seller company have the same business code.

5. The system of claim 1, wherein the seller setting module further includes an allocating module to allocate the order to other affiliates.

6. The system of claim 1, wherein the buyer representative is elected according to an amount of purchase, a type of product to be purchased or a buyer's location.

7. A multi-parties transaction process, implemented in a quotation between companies, the process comprising:
integrating product needs of affiliates of one buyer company, electing a buyer representative and setting a transport agreement according to all the needs;
integrating offers of affiliates of one seller company to set one quotation price according to the agreement and elect one seller representative;
comparing the quotation prices offered by different seller representatives to obtain an order price offered by a winner seller representative;
making an order to the winner seller representative at the order price; and
allocating the order to other affiliates of the winner seller representative.

8. The process of claim 7, wherein the transport agreement describes a destination for the goods.

9. The process of claim 7, wherein the buyer representative is elected according to an amount of purchase, a type of product to be purchased or a buyer's location.

10. The process of claim 7, wherein the affiliates of one seller company have the same business code.
